(19) United States
(12) Patent Application Publication
(10) Pub. No.: US 2018/0273718 A1
(43) Pub. Date: Sep. 27, 2018

(54) METHOD FOR PREPARING FOAMED STRUCTURE

(71) Applicant: Dongguan Hailex High Polymer Material Science and Technology, Co., Ltd., Dongguan, Guangdong (CN)

(72) Inventors: Zhenhuan LUO, Songshan Lake, Guangdong (CN); Xiongxiong CAI, Nanxiong City, Guangdong (CN); Fuqi LIU, Yaojiang Area, Hunan (CN)

(21) Appl. No.: 15/542,752

(22) PCT Filed: Dec. 2, 2016
(86) PCT No.: PCT/CN2016/108379

§ 371 Date: Jul. 11, 2017

(51) Int. Cl. C08J 9/12

(52) U.S. Cl. CPC C08J 9/122; C08J 2203/06; C08J 2205/044; C08J 2375/04; C08J 2367/00; C08J 2203/08

(57) ABSTRACT

The present disclosure relates to a method for preparing a foamed structure, comprising: providing a preform prepared from one or more of thermoplastic materials, in which the preform has corresponding shape of the foamed structure; subjecting the preform to a first treatment with a first supercritical fluid at a first temperature and a first pressure; optionally, subjecting the preform treated with the first supercritical fluid to a second treatment with a second supercritical fluid at a second temperature and a second pressure; and foaming the resulting preform into a structure having predetermined shape and size.

### TECHNICAL FIELD

The present disclosure relates to a method for preparing a foamed structure, and more particularly, to a method for preparing a foam having single-hardness or multiple-hardness.

### BACKGROUND ART

At present, foamed materials are mainly formed by primary or secondary crosslinking-foaming of materials such as two-liquid type polyurethane (PU), rubber, ethylene vinyl acetate (EVA), polyethylene (PE), polyolefin elastomer (POE), styrene copolymer (SBS or SEBS) or the like. It is necessary for a dual-hardness foamed structure to use an adhesive for sizing-bonding and other processes. Such foamed materials require the use of various organic or inorganic chemical foaming agents, crosslinking agents, additives or the like in the preparation process, and therefore causes problems such as chemical residues, which have a certain degree of adverse effects on human body or environment. Generally, multiple processing procedures and bonding procedures are required after the foaming process, so that a single-hardness or dual-hardness finished product with a final size can be obtained.

In recent years, supercritical fluid technology (such as supercritical carbon dioxide technology, supercritical nitrogen technology, etc.) has been used to produce foamed materials. Although the supercritical fluid technology has clean and environmentally friendly feature, it has low production efficiency and is difficult to be used for industrial large-scale production because of the requirement of using high-pressure and/or high-temperature equipment such as autoclave. The foamed structure obtained by such supercritical technology has problems such as difficulty in controlling the foaming rate, insufficient resilience, etc. Moreover, the size of the resulting foamed structure cannot be exactly controlled and therefore it is still necessary to finish the product to obtain the final size. Furthermore, since such supercritical fluid technology still needs the use of an adhesive in the preparation of a dual-hardness product, there are problems such as environmental pollution, inability to achieve 100% recovery, etc.

In view of the above, the present disclosure provides a novel method for preparing foamed structure that solves one or more of the existing problems in the art.

### SUMMARY

In one aspect of the present disclosure, provided is a method for preparing a foamed structure, comprising:

providing a preform prepared from one or more of thermoplastic materials, in which the preform has corresponding shape of the foamed structure;

subjecting the preform to a first treatment with a first supercritical fluid at a first temperature and a first pressure;

optionally, subjecting the preform treated with the first supercritical fluid to a second treatment with a second supercritical fluid at a second temperature and a second pressure; and

foaming the resulting preform into a structure having predetermined shape and size.

According to one embodiment of the present disclosure, the first temperature and the second temperature are identical to or different from each other, and are each 30° C. to 200° C. According to another embodiment of the present disclosure, the first pressure and the second pressure are identical to or different from each other, and are each 5 MPa to 60 MPa.

According to one embodiment of the present disclosure, the first supercritical fluid and the second supercritical fluid are identical to or different from each other, and are each selected from the group consisting of carbon dioxide, water, methane, ethane, ethylene, propylene, methanol, ethanol, acetone, nitrogen gas and combinations thereof.

According to one embodiment of the present disclosure, each of the first treatment and the second treatment are carried out for 5 minutes to 1 hour. According to another embodiment of the present disclosure, the first treatment comprises carrying out the treatment at a temperature of 90° C. to 180° C. and a pressure of 6 MPa to 40 MPa for 10 minutes to 50 minutes, and then optionally cooling to 50° C. or below. According to yet another embodiment of the present disclosure, the first treatment comprises carrying out the treatment at a temperature of 100° C. to 150° C. and a pressure of 6.9 MPa to 34.5 MPa for 10 minutes to 50 minutes, and then optionally cooling to 50° C. or below. According to still another embodiment of the present disclosure, the second treatment comprises carrying out the treatment at a temperature of 50° C. to 180° C. and a pressure of 10 MPa to 60 MPa for 15 minutes to 40 minutes.

According to one embodiment of the present disclosure, the thermoplastic materials are selected from the group consisting of polyurethane, rubber, ethylene vinyl acetate, polyolefin, polystyrene copolymer, polyvinyl chloride, polyethylene terephthalate, thermoplastic acrylate and any combinations thereof. According to another embodiment of the present disclosure, the thermoplastic material is a thermoplastic polyurethane material represented by Formula 1:

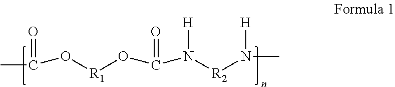

wherein R₁ and R₂ are each independently selected from the group consisting of substituted or unsubstituted linear or branched C₁₋₁₂ alkyl group, substituted or unsubstituted phenyl group, substituted or unsubstituted linear or branched C₁₋₁₂ alkylphenyl group, substituted or unsubstituted linear or branched C₁₋₁₂ ether group, substituted or unsubstituted linear or branched C₁₋₁₂ alkylhydroxy group, substituted or unsubstituted linear or branched C₁₋₁₂alkoxy group, and substituted or unsubstituted linear or branched C₃₋₁₂ cycloalkoxy group, wherein n is any integer of less than or equal to 150.

According to one embodiment of the present disclosure, the preform is produced by injection molding, extrusion molding, hot-press molding or casting molding.

In another aspect of the present disclosure, provided is a foamed structure prepared by the method described above.

In yet another aspect of the present disclosure, provided is use of the foamed structure described above in sports equipment, packaging materials, or shoe materials.

### BRIEF DESCRIPTION OF DRAWINGS

Exemplary embodiments are described in detail below with reference to the accompanying drawings. The drawings are provided merely to make those skilled in the art better understand the present disclosure, and are not intended to limit the scope thereof.

FIG. 1 is a flow diagram of a method for manufacturing a foamed structure according to one embodiment of the present disclosure;

FIG. 2 is a top view of a foamed structure according to one embodiment of the present disclosure;

FIG. 3 is a longitudinal sectional view of a foamed structure according to one embodiment of the present disclosure;

FIG. 4 is a transverse section view of a foamed structure according to one embodiment of the present disclosure;

FIG. 5 is a diagram of an apparatus for preparing a thermoplastic material preform into a foamed structure according to one embodiment of the present disclosure.

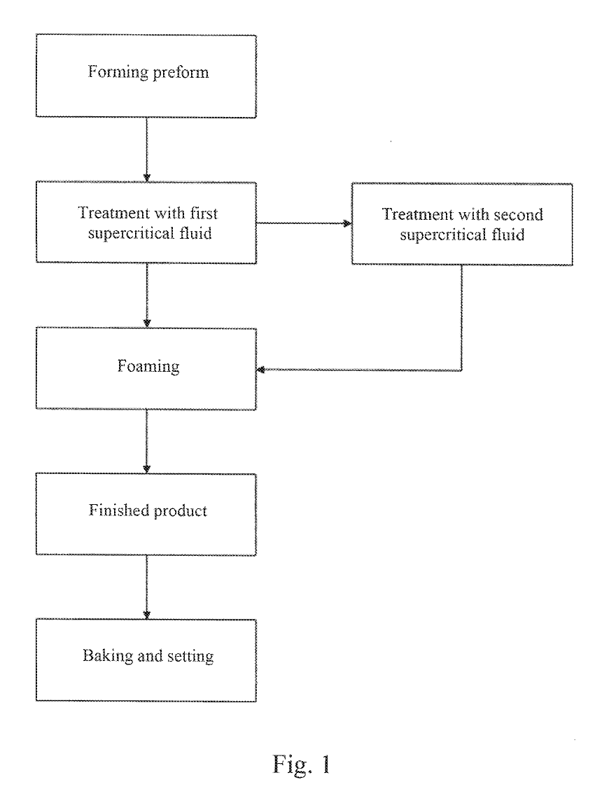

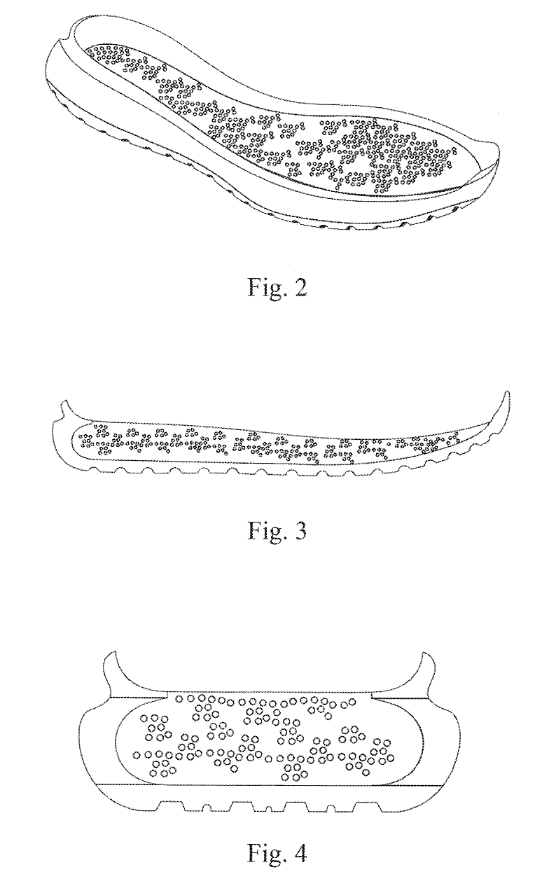

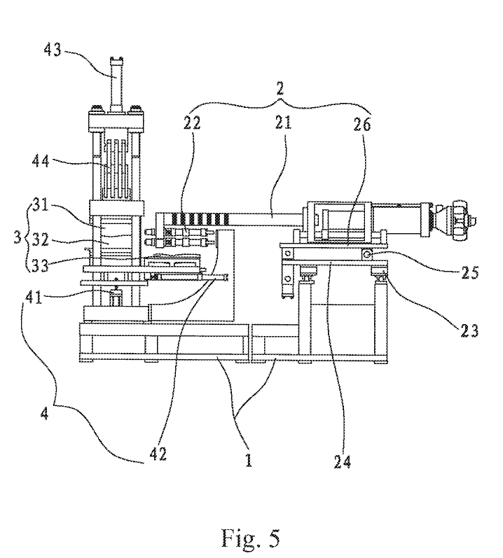

In FIG. 5: rack-1; feeding mechanism-2; injector-21; adapter-22; linear guide for feeding-23; lower tray-24; rotating base-25; upper tray-26; forming mold-3; upper mold-31; middle mold-32; lower mold-33; mold-opening/pulling mechanism-4; rising cylinder-41; mold-shifting cylinder-42; mold-opening/closing cylinder-43; crank assembly-44.

### DETAILED DESCRIPTION

In the following description, for the purpose of explanation, multiple specific details are set forth in order to provide a thorough understanding of various exemplary embodiments. However, it will be apparent that the exemplary embodiments may be practiced without these specific details or with one or more equivalent arrangements. In the drawings, the dimensions and relative dimensions of elements may be exaggerated for the purpose of clarity and description, and the shapes of these elements are exemplary only and are not intended to limit the embodiments of the present disclosure. Although the terms “first”, “second”, or the like may be used herein to describe various elements, these elements should not be limited by such terms. The terms are only used to distinguish one element from another. Therefore, first temperature, first pressure, first supercritical fluid and the like used hereinafter could be construed as second temperature, second pressure, second supercritical fluid and the like, without departing from the teachings of the present disclosure

Spatially relative terms, such as “beneath,” “below,” “lower”, “top”, “above” “upper” and the like, are used herein for ease of description to describe one element's relationship to another element(s) as illustrated in the figures. The spatially relative terms are intended to encompass different orientations of the device in use, operation and/or manufacture. For example, if the device is turned over, elements described as “below” or “beneath” the other elements or features would then be oriented “above” the other elements or features. Thus, the exemplary term “below” can encompass both an orientation of above and below. Moreover, the device can be otherwise oriented (for example, rotated at 90 degrees or at other orientations) and the spatially relative descriptors used herein shall be interpreted accordingly.

The terminology used herein is for the purpose of describing particular embodiments only and is not intended to limit the invention. As used herein, the singular forms are intended to include plural forms as well, unless the context clearly indicates otherwise. Moreover, the terms “comprise”, “comprises”, “comprising” and “include”, “includes”, “including”, when used in the specification, specify the presence of stated features, steps, operations, elements, components and the like, but do not preclude the presence of one or more other features, steps, operations, elements, components and the like.

Unless otherwise defined, all terms (including technical and scientific terms) used herein have the same meaning as commonly understood by one of ordinary skill in the art to which the present application belongs. Terms, such as those defined in commonly used dictionaries, should be interpreted as having meaning that is consistent with their meaning in the context of the relevant art, and will not be interpreted in an idealized or overly formal sense, unless expressly so defined herein.

### Definitions

As used herein, the term “preform” refers to an un-foamed structure that corresponds to the shape of the finished product, but three dimensions thereof are smaller.

As used herein, the term “supercritical fluid” refers to a fluid in which its temperature and pressure reach certain critical points, and sometimes, a fluid in which its temperature or pressure reaches certain critical point is also referred to as a “supercritical fluid”. Generally, the physical properties of supercritical fluid are between those of gas phase and those of liquid phase, and such supercritical fluid has the advantages, such as low viscosity, high density, high diffusion coefficient, high solubility in organics.

As used herein, the term “foamed structure” refers to a three-dimensional body having a porous structure obtained by a foaming process, but commonly used pellets, microparticles and the like are not included within the scope of this term.

As used herein, the term “thermoplastic polyurethane (TPU)” refers to a polymer material formed by a polymerization reaction of diisocyanate (such as diphenyl methane diisocyanate (MDI), toluene diisocyanate (TDI), and the like) with a macromolecular polyol and/or a low molecular weight polyol (chain extender).

As used herein, the term “C₁₋₁₂” means that the main chain of a group has any carbon number in the range of 1 to 12, for example, 1, 2, 3, 4, 5, 6, 7, 8, 9, 10, 11 or 12 carbon atoms.

As used herein, the term “substituted” refers to substitution with C₁₋₃₀ alkyl group, for example, C₁₋₁₀ alkyl group, such as methyl, ethyl, propyl, isopropyl, butyl, sec-butyl, tert-butyl, pentyl, hexyl, heptyl, octyl, nonyl, decyl or the like; C₆₋₃₀ aryl group, for example, C₆₋₁₈ aryl group, such as phenyl, naphthyl, biphenyl, terphenyl or the like; C₁₋₃₀ alkoxy (—OA₁) group wherein A₁ is a C₁₋₃₀ alkyl group as defined herein, for example, C₁₋₁₀ alkoxy group; C₁₋₃₀ alkylhydroxy (-A₂OH) group, wherein A₂ is a C₁₋₃₀ alkyl group as defined herein, for example, C₁₋₁₀ alkylhydroxy group; C₃₋₃₀ cycloalkyl group, for example, C₃₋₁₀ cycloalkyl group, such as cyclopropyl, cyclobutyl, cyclopentyl, cyclohexyl, cycloheptyl or the like; C₃₋₃₀ cycloalkoxy (—OA₃) group wherein A₃ is a C₃₋₃₀ cycloalkyl group as defined herein, for example, C₃₋₁₀ cycloalkoxy group.

### Method for Preparing Foamed Structure

According to one embodiment of the present disclosure, the method of preparing a foamed structure comprises: providing a preform prepared from one or more of thermoplastic materials, in which the preform has corresponding shape of the foamed structure; subjecting the preform to a first treatment with a first supercritical fluid at a first temperature and a first pressure; optionally subjecting the perform treated with the first supercritical fluid to a second treatment with a second supercritical fluid at a second temperature and a second pressure; and foaming the resulting preform into a structure having predetermined shape and size.

According to one embodiment of the present disclosure, the first temperature and the second temperature may be identical to or different from each other. According to another embodiment of the present disclosure, each of the first temperature and the second temperature may be 30° C. to 200° C. According to yet another embodiment of the present disclosure, each of the first temperature and the second temperature may be 50° C. to 180° C. According to other embodiments of the present disclosure, each of the first temperature and the second temperature may be 70° C. to 160° C. According to another embodiment of the present disclosure, each of the first temperature and the second temperature may be 90° C. to 150° C. According to yet another embodiment of the present disclosure, each of the first temperature and the second temperature may be 120° C. to 140° C.

According to one embodiment of the present disclosure, the first pressure and the second pressure may be identical to or different from each other. According to another embodiment of the present disclosure, each of the first pressure and the second pressure may be 5 MPa to 60 MPa. According to yet another embodiment of the present disclosure, each of the first pressure and the second pressure may be 6 MPa to 55 MPa. According to other embodiments of the present disclosure, each of the first pressure and the second pressure may be 7 MPa to 50 MPa. According to another embodiment of the present disclosure, each of the first pressure and the second pressure may be 12 MPa to 34 MPa or 35 MPa. According to yet another embodiment of the present disclosure, each of the first pressure and the second pressure may be 15 MPa to 20 MPa.

According to one embodiment of the present disclosure, the first supercritical fluid and the second supercritical fluid may be identical to or different from each other. According to another embodiment of the present disclosure, each of the first supercritical fluid and the second supercritical fluid may be selected from the group consisting of carbon dioxide, water, methane, ethane, ethylene, propylene, methanol, ethanol, acetone, nitrogen gas and combinations thereof. According to yet another embodiment of the present disclosure, each of the first supercritical fluid and the second supercritical fluid may be selected from the group consisting of carbon dioxide, nitrogen gas, and a combination thereof.

According to one embodiment of the present disclosure, each of the first supercritical fluid treatment and the second supercritical fluid treatment may be carried out at a fluid pressure of 5 MPa to 60 MPa. According to yet another embodiment of the present disclosure, each of the first supercritical fluid treatment and the second supercritical fluid treatment may be carried out at a fluid pressure of 6 MPa to 55 MPa. According to other embodiments of the present disclosure, each of the first supercritical fluid treatment and the second supercritical fluid treatment may be carried out at a fluid pressure of 7 MPa to 50 MPa. According to another embodiment of the present disclosure, each of the first supercritical fluid treatment and the second supercritical fluid treatment may be carried out at a fluid pressure of 12 MPa to 34 MPa or 35 MPa. According to yet another embodiment of the present disclosure, each of the first supercritical fluid treatment and the second supercritical fluid treatment may be carried out at a fluid pressure of 15 MPa to 20 MPa.

According to one embodiment of the present disclosure, the fluid pressure of the first supercritical fluid may be identical to the first pressure. According to another embodiment of the present disclosure, the fluid pressure of the second supercritical fluid may be identical to the second pressure. According to one embodiment of the present disclosure, the fluid pressure of the first supercritical fluid may be different from the first pressure. According to another embodiment of the present disclosure, the fluid pressure of the second supercritical fluid may be different from the second pressure.

According to one embodiment of the present disclosure, each of the first supercritical fluid and the second supercritical fluid may have a fluid temperature of 50° C. to 220° C. According to another embodiment of the present disclosure, each of the first supercritical fluid and the second supercritical fluid may have a fluid temperature of 70° C. to 200° C. According to yet another embodiment of the present disclosure, each of the first supercritical fluid and the second supercritical fluid may have a fluid temperature of 90° C. to 180° C. According to another embodiment of the present disclosure, each of the first supercritical fluid and the second supercritical fluid may have a fluid temperature of 120° C. to 160° C. According to yet another embodiment of the present disclosure, each of the first supercritical fluid and the second supercritical fluid may have a fluid temperature of 140° C. to 150° C.

According to one embodiment of the present disclosure, the fluid temperature of the first supercritical fluid may be identical to the first temperature. According to another embodiment of the present disclosure, the fluid temperature of the second supercritical fluid may be identical to the second temperature. According to one embodiment of the present disclosure, the fluid temperature of the first supercritical fluid may be different from the first temperature. According to another embodiment of the present disclosure, the fluid temperature of the second supercritical fluid may be different from the second temperature.

According to one embodiment of the present disclosure, the pressure of each of the first supercritical fluid and the second supercritical fluid may be maintained for 5 minutes to 1 hour. According to one embodiment of the present disclosure, the pressure of each of the first supercritical fluid and the second supercritical fluid may be maintained for 10 minutes to 50 minutes. According to yet another embodiment of the present disclosure, the pressure of each of the first supercritical fluid and the second supercritical fluid may be maintained for 15 minutes to 40 minutes. According to other embodiments of the present disclosure, the pressure of each of the first supercritical fluid and the second supercritical fluid may be maintained for 20 minutes to 30 minutes.

According to one embodiment of the present disclosure, the first treatment may comprise carrying out the treatment at a temperature of 90° C. to 180° C. and a pressure of 10 MPa to 40 MPa for 10 minutes to 50 minutes, and then optionally cooling to 50° C. or below. According to another embodiment of the present disclosure, the first treatment may comprise carrying out the treatment at a temperature of 100° C. to 150° C. and a pressure of 10 MPa to 40 MPa for 20 minutes to 30 minutes, and then optionally cooling to 30° C. or below. According to one embodiment of the present disclosure, the second treatment may comprise carrying out the treatment at a temperature of 50° C. to 180° C. and a pressure of 10 MPa to 60 MPa for 15 minutes to 40 minutes. According to one embodiment of the present disclosure, the second treatment may comprise carrying out the treatment at a temperature of 90° C. to 160° C. and a pressure of 10 MPa to 60 MPa for 15 minutes to 40 minutes.

According to one embodiment of the present disclosure, the thermoplastic material may be selected from the group consisting of polyurethane, rubber, ethylene vinyl acetate, polyolefin, polystyrene copolymer, polyvinyl chloride, polyethylene terephthalate, thermoplastic acrylate and any combinations thereof. According to yet another embodiment of the present disclosure, the thermoplastic material may be a thermoplastic polyurethane material represented by Formula 1:

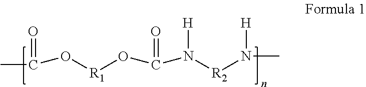

wherein R₁ and R₂ may be each independently selected from the group consisting of substituted or unsubstituted linear or branched C₁₋₁₂ alkyl group, substituted or unsubstituted phenyl group, substituted or unsubstituted linear or branched C₁₋₁₂ alkylphenyl group, substituted or unsubstituted linear or branched C₁₋₁₂ ether group, substituted or unsubstituted linear or branched C₁₋₁₂ alkylhydroxy group, substituted or unsubstituted linear or branched C₁₋₁₂ alkoxy group, and substituted or unsubstituted linear or branched C₃₋₁₂ cycloalkoxy group, wherein n is any integer of less than or equal to 150.

The substituent for substituted linear or branched C₁₋₁₂ alkyl group, substituted phenyl group, substituted linear or branched C₁₋₁₂ alkylphenyl group, substituted linear or branched C₁₋₁₂ ether group, substituted linear or branched C₁₋₁₂ alkylhydroxy group, substituted linear or branched C₁₋₁₂ alkoxy group, or substituted linear or branched C₃₋₁₂ cycloalkoxy group may be selected from the group consisting of C₁₋₃₀ alkyl group, C₁₋₁₈ alkyl group, C₁₋₁₂ alkyl group or C₁₋₆ alkyl group; C₅₋₃₀ aryl group, C₆₋₁₈ aryl group, C₆₋₁₂ aryl group or phenyl group; C₁₋₃₀ alkoxy group, C₁₋₁₈ alkoxy group, C₁₋₁₂ alkoxyl group or C₁₋₆ alkoxy group; C₁₋₃₀ alkylhydroxy group, C₁₋₁₈ alkylhydroxy group, C₁₋₁₂ alkylhydroxy group or C₁₋₆ alkylhydroxy group; C₃₋₃₀ cycloalkyl group, C₃₋₁₈ cycloalkyl group, C₃₋₁₂ cycloalkyl group, C₃₋₆ cycloalkyl group; C₃₋₃₀ cycloalkoxy group, C₃₋₁₈ cycloalkoxy group, C₃₋₁₂ cycloalkoxy group, C₃₋₆ cycloalkoxy group.

Specifically, the above-mentioned substituents may be, but not limited to, methyl, ethyl, propyl, isopropyl, butyl, sec-butyl, t-butyl, pentyl, hexyl; phenyl, biphenyl, terphenyl; methoxy, ethoxy, propoxy, butoxy, pentyloxy, hexyloxy; methylhydroxy, ethylhydroxyl, propylhydroxy, butylhydroxy, pentylhydroxy, hexylhydroxy; cyclopropyl, cyclopentyl, cyclohexyl; cyclopropyloxy, cyclopentyloxy, cyclohexyloxy.

According to one embodiment of the present disclosure, the preform can be produced by injection molding, extrusion molding, hot-press molding or casting molding. According to another embodiment of the present disclosure, the preform may be produced by injection molding.

According to one embodiment of the present disclosure, the foamed structure is made from one or more of thermoplastic materials by supercritical fluid foaming. According to one embodiment of the present disclosure, the foamed structure is made from a thermoplastic polyurethane material by supercritical fluid foaming. According to one embodiment of the present disclosure, the foamed structure is made from the thermoplastic polyurethane material represented by Formula 1 by supercritical carbon dioxide foaming or supercritical nitrogen gas foaming.

According to one embodiment of the present disclosure, a method for preparing a foamed structure is foaming the preform, which is subjected to the first treatment, to directly obtain a structure having predetermined shape and size without a subsequent finishing step. According to another embodiment of the present disclosure, a method for preparing a foamed structure is foaming the preform, which is subjected to the second treatment, to directly obtain a structure having predetermined shape and size without a subsequent finishing step.

According to one embodiment of the present disclosure, the first treatment and the second treatment are carried out in the same mold. According to another embodiment of the present disclosure, the first treatment and the second treatment are carried out in different molds. According to yet another embodiment of the present disclosure, the preform, which is subjected to the first treatment or the second treatment, is foamed into a structure having predetermined shape and size in accordance with the shape and size of the mold.

According to one embodiment of the present disclosure, the method for preparing the foamed structure described herein can be used for directly manufacturing sports equipment, packaging materials, or shoe materials. According to another embodiment of the present disclosure, the method for preparing the foamed structure described herein can be used to directly obtain a shoe sole without a subsequent processing step.

### Foamed Structure

According to one embodiment of the present disclosure, the foamed structure is a non-corrugated foamed structure. According to one embodiment of the present disclosure, the foamed structure may have an average resilience coefficient of greater than 45% as measured by the ASTM D-2632 method. According to another embodiment of the present disclosure, the foamed structure may have an average resilience coefficient of 50% or more, for example, 51% or more, 52% or more, 53% or more, 54% or more, as measured by the ASTM D-2632 method. According to still another embodiment of the present disclosure, the foamed structure may have an average resilience coefficient of 55% or more as measured by the ASTM D-2632 method. According to other embodiments of the present disclosure, the foamed structure may have an average resilience coefficient of 60% or more as measured by the ASTM D-2632 method.

According to one embodiment of the present disclosure, the foamed structure has single average resilience coefficient or double average resilience coefficients, and each average resilience coefficient is greater than 45%. According to another embodiment of the present disclosure, the foamed structure has single average resilience coefficient or double average resilience coefficients, and each average resilience coefficient is 50% or more, for example, 51% or more, 52% or more, 53% or more, 54% or more, or 55% or more.

According to one embodiment of the present disclosure, the foamed structure may have an average pore size of 99 μm or less. According to another embodiment of the present disclosure, the foamed structure may have an average pore size of 35 μm to 55 μm. According to yet another embodiment of the present disclosure, the foamed structure may have an average pore size of 45 μm to 50 μm.

According to one embodiment of the present disclosure, the foamed structure may have a specific gravity of 0.7 or less as measured by the ASTM D-297 method. According to another embodiment of the present disclosure, the foamed structure may have a specific gravity of 0.1 to 0.7 as measured by the ASTM D-297 method. According to yet another embodiment of the present disclosure, the foamed structure may have a specific gravity of 0.17 to 0.65 as measured by the ASTM D-297 method. According to another embodiment of the present disclosure, the foamed structure may have a specific gravity of 0.2 to 0.6 as measured by the ASTM D-297 method. According to yet another embodiment of the present disclosure, the foamed structure may have a specific gravity of 0.25 to 0.55 as measured by the ASTM D-297 method. According to another embodiment of the present disclosure, the foamed structure may have a specific gravity of 0.3 to 0.5 as measured by the ASTM D-297 method. According to yet another embodiment of the present disclosure, the foamed structure may have a specific gravity of 0.35 to 0.45 as measured by the ASTM D-297 method.

According to one embodiment of the present disclosure, the foamed structure may have a single-hardness. According to another embodiment of the present disclosure, the foamed structure may have a dual-hardness. According to one embodiment of the present disclosure, each hardness value may be in the range of 10 to 80 based on Shore hardness determined by the ASTM D-2240 method. According to another embodiment of the present disclosure, each hardness value may be in the range of 20 to 75 based on Shore hardness determined by the ASTM D-2240 method. According to yet another embodiment of the present disclosure, each hardness value may be in the range of 30 to 70 based on Shore hardness determined by the ASTM D-2240 method. According to another embodiment of the present disclosure, each hardness value may be in the range of 35 to 68 based on Shore hardness determined by the ASTM D-2240 method. According to still another embodiment of the present disclosure, each hardness value may be in the range of 40 to 60 based on Shore hardness determined by the ASTM D-2240 method. According to another embodiment of the present disclosure, each hardness value may be in the range of 42 to 55 based on Shore hardness determined by the ASTM D-2240 method. According to yet another embodiment of the present disclosure, each hardness value may be in the range of 45 to 50 based on Shore hardness determined by the ASTM D-2240 method.

According to one embodiment of the present disclosure, the foamed structure may have an expansion ratio of 1.4 to 1.7. According to another embodiment of the present disclosure, the foamed structure may have an expansion ratio of 1.45 to 1.65. According to yet another embodiment of the present disclosure, the foamed structure may have an expansion ratio of 1.5 to 1.6. According to one embodiment of the present disclosure, the foamed structure may have an expansion ratio of 1.55.

According to one embodiment of the present disclosure, the foamed structure produces different degrees of wrinkles when compressed or twisted to a deformation of 10% to 20%; when the deformation reaches 50%, if the external force is maintained for 10 seconds and then released, the wrinkles disappear within 0-600 seconds. According to another embodiment of the present disclosure, the foamed structure produces different degrees of wrinkles when compressed or twisted to a deformation of 10% to 20%; when the deformation reaches 50%, if the external force is maintained for 3 seconds and then released, the wrinkles disappear immediately (for example, less than 1 second).

According to one embodiment of the present disclosure, the foamed structure is a foamed structure obtained by the method described herein. According to another embodiment of the present disclosure, the foamed structure is a foamed structure obtained by methods other than those described herein.

According to one embodiment of the present disclosure, the foamed structures described herein can be used in sports equipment, packaging materials, or shoe materials. According to another embodiment of the present disclosure, the foamed structure described herein can be used as a shoe sole material.

### EXAMPLES

The following examples are provided to illustrate the features of one or more embodiments, but it will be understood that these examples cannot be construed to limit the scope of the invention.

Thermoplastic polyurethane (TPU) available from BASF Corporation under the trade name Elastollan 1180A, 1185A, 1190A, and thermoplastic polyester copolymer elastomer (TPEE) available from DuPont Corporation under the trade name Hytrel 3078, were used in the following examples.

### Example 1: General Molding Procedure

Thermoplastic particles were molded into a desired preform through an injection machine, in which the preform was proportionally shrunken according to the expansion ratio. The preform was then placed into a mold having specific temperature as mentioned above and allowed to achieve heat balance. Supercritical carbon dioxide or nitrogen gas was injected into the mold, pressurized and held for a period of time. After supercritical carbon dioxide or nitrogen gas infiltrated into the preform, a coolant liquid was passed through the mold and the supercritical carbon dioxide or nitrogen gas was vented. The preform was foamed by opening the mold and releasing pressure of the mode (generally, the speed of opening the mold is 200 mm/sec or higher) or by heating the mold, to directly obtain a finished product, which only needs baking and setting before use, without any subsequent finishing of size and/or shape.

Optionally, after the supercritical carbon dioxide or nitrogen gas was vented, according to actual requirements, supercritical carbon dioxide or nitrogen gas may be reintroduced, pressurized and held for a period of time to perform secondary infiltration, which can control the expansion ratio of the preform.

### Example 2: Foaming of Elastollan 1180A

100 parts by weight of Elastollan 1180A particles were placed in a feed bucket of a plastic injection machine, then fed and melted via the screw of the injection machine, and injected into a preform mold upon measurement, thereby molding into a desired preform, wherein processing temperature: 130˜200° C.; preform size: 150 mm×90 mm 3˜10 mm.

Next, the preform was placed in a mold having a temperature of 90˜180° C. In a supply tank, carbon dioxide was adjusted to a fluid pressure of 6.9 MPa˜34.5 MPa and a temperature of 90˜180° C., so that the carbon dioxide in the tank was in a supercritical fluid state.

Then, the supercritical fluid inlet valve on the mold was opened to inject the supercritical carbon dioxide into the mold, and the pressure was maintained at 6.9 MPa˜34.5 MPa and held for 10˜50 minutes. After the supercritical fluid infiltrated into the preform, a coolant liquid was passed through the mold and the supercritical fluid was vented so that the preform was foamed and expanded. A foamed finished product having desired structure and shape was obtained after opening the mold.

### Example 3: Foaming of Elastollan 1185A

100 parts by weight of Elastollan 1185A particles were placed in a feed bucket of a plastic injection machine, then fed and melted via the screw of the injection machine, and injected into a preform mold upon measurement, thereby molding into a desired preform, wherein processing temperature: 130˜200° C.; preform size: 150 mm×90 mm×3˜10 mm.

Next, the preform was placed in a mold having a temperature of 90˜180° C. In a supply tank, carbon dioxide is adjusted to a fluid pressure of 6.9 MPa˜34.5 MPa and a temperature of 90˜180° C., so that the carbon dioxide in the tank is in a supercritical fluid state.

Then, the supercritical fluid inlet valve on the mold was opened to inject the supercritical carbon dioxide into the mold, and the pressure was maintained at 6.9 MPa˜34.5 MPa and held for 10˜50 minutes. After the supercritical fluid infiltrated into the preform, a coolant liquid was passed through the mold and the supercritical fluid was vented so that the preform was foamed and expanded. A foamed finished product having a desired structure and shape was obtained after opening the mold.

### Example 4: Foaming of Elastollan 1190A

100 parts by weight of Elastollan 1190A particles were placed in a feed bucket of a plastic injection machine, then fed and melted via the screw of the injection machine, and injected into a preform mold upon measurement, thereby molding into a desired preform, wherein processing temperature: 130˜200° C.; preform size: 150 mm×90 mm×3˜10 mm.

Next, the preform was placed in a mold having a temperature of 90˜180° C. In a supply tank, carbon dioxide was adjusted to a fluid pressure of 6.9 MPa˜34.5 MPa and a temperature of 90˜180° C., so that the carbon dioxide in the tank was in a supercritical fluid state.

Then, the supercritical fluid inlet valve on the mold was opened to inject the supercritical carbon dioxide into the mold, and the pressure was maintained at 6.9 MPa˜34.5 MPa and held for 10˜50 minutes. After the supercritical fluid infiltrated into the preform, a coolant liquid was passed through the mold and the supercritical fluid was vented so that the preform was foamed and expanded. A foamed finished product having desired structure and shape was obtained after opening the mold.

### Example 5: Foaming of a Mixture of Elastollan 1180A and Elastollan 1185A

Elastollan 1180A particles and Elastollan 1185A particles were placed in a feed bucket of a plastic injection machine, then fed and melted via the screw of the injection machine, and injected into a preform mold upon measurement, thereby molding into a desired preform having dual-hardness, wherein processing temperature: 130˜200° C.; preform size: 150 mm×90 mm×3˜10 mm.

Next, the preform having dual-hardness was placed in a mold having a temperature of 90˜150° C. In a supply tank, carbon dioxide was adjusted to a fluid pressure of 6.9 MPa˜34.5 MPa and a temperature of 90˜150° C., so that the carbon dioxide in the tank was in a supercritical fluid state.

Then, the supercritical fluid inlet valve on the mold was opened to inject the supercritical carbon dioxide into the mold, and the pressure was maintained at 6.9 MPa˜34.5 MPa and held for 10˜50 minutes. After the supercritical fluid infiltrated into the preform, a coolant liquid was passed through the mold and the supercritical fluid was vented so that the preform was foamed and expanded. A foamed finished product having desired structure and shape was obtained after opening the mold.

### Examples 6-12

A foamed finished product having desired structure and shape was prepared according to the same process as in Example 1, using the materials and parameters as shown in Table 1 below.

TABLE 1

| | | | Supercritical | Supercritical | | | |
|---|---|---|---|---|---|---|---|
| Example | | Supercritical | fluid pressure | fluid temperature | Mold pressure | Mold temperature | holding time |
| No. | Thermoplastic material | fluid | (MPa) | (° C.) | (MPa) | (° C.) | (min) |
| 6 | Elastollan 1180A | carbon dioxide | 6.9~34.5 | 90~140 | 6.9~34.5 | 90~140 | 10~50 |
| 7 | Elastollan 1185A | carbon dioxide | 13.8~34.5 | 90~150 | 13.8~34.5 | 120~150 | 15~50 |
| 8 | Elastollan 1190A | carbon dioxide | 6.9~34.5 | 90~160 | 6.9~34.5 | 90~160 | 10~50 |
| 9 | Hytrel 3078 | carbon dioxide | 6.9~34.5 | 120~180 | 6.9~34.5 | 90~150 | 10~40 |
| 10 | Elastollan 1185A | carbon dioxide | 6.9~20.7 | 90~140 | 6.9~20.7 | 90~140 | 5~30 |
| 11 | Elastollan 1185A | nitrogen gas | 6.9~34.5 | 90~140 | 6.9~34.5 | 90~140 | 10~30 |
| 12 | Elastollan 1180A and | carbon dioxide | 6.9~34.5 | 90~150 | 6.9~34.5 | 90~150 | 10~50 |
| | Elastollan 1185A | | | | | | |

The physical properties of the foamed materials of Examples 2 to 8 described above were tested below with reference to Table 2. The test methods are ASTM D-2632 (resilience test), ASTM D-297 (specific gravity test), ASTM D-2240 (hardness test), respectively. The data listed in Table 2 are the averages of at least three repeated tests.

TABLE 2

| | | Average | Average | | |
|---|---|---|---|---|---|
| Example | Specific | pore | resilience | Expansion | Shore |
| No. | gravity | size (μm) | coefficient (%) | ratio | hardness |
| 2 | 0.26 | 55 | 55 | 1.55 | 35 |
| 3 | 0.17 | 45 | 54 | 1.65 | 42 |
| 4 | 0.25 | 35 | 53 | 1.65 | 52 |
| 5 | 0.27 | 50 | 55/53 | 1.6 | 38/45 |
| 6 | 0.55 | 45 | 50 | 1.5 | 55 |
| 7 | 0.6 | 55 | 50 | 1.45 | 68 |
| 8 | 0.65 | 50 | 51 | 1.4 | 65 |

The surfaces of the finished products of the foamed structures obtained according to the above-described examples of the present disclosure are compressed by hand, when deformation reaches 10% to 20%, different degrees of wrinkles begin to occur; when deformation reaches 50%, compression is maintained for 3 seconds and then released, the wrinkles disappear immediately.

Moreover, in all embodiments of the present disclosure, the main component of the foamed structure is a thermoplastic polymeric elastomer material, and the foaming agent is a supercritical fluid. In addition, the foamed materials of the present disclosure have high resilience, light weight, no chemical residue, and are environmentally friendly, thereby achieving 100% recovery. Such foamed materials may have dual-hardness and high foaming consistency. The preparation method of the foamed structure described in the present disclosure has advantages, for example, it can achieve mass production, do not need secondary processing, is non-toxic and environmentally friendly, and has low production cost.

It will be understood that exemplary embodiments described herein should be considered in a descriptive sense only and not for the purposes of limitation. Description of features or aspects within each exemplary embodiment should be considered to be available for other similar features or aspects in other exemplary embodiments.

Although certain exemplary embodiments and implementations have been described herein, other embodiments and modifications will be apparent from such description. Accordingly, the inventive concept is not limited to those embodiments, but limited to the scope of the presented claims and various equivalent arrangements thereof.

1. A method for preparing a foamed structure, comprising:
providing a preform prepared from one or more of thermoplastic materials, in which the preform has corresponding shape of the foamed structure;
subjecting the preform to a first treatment with a first supercritical fluid at a first temperature and a first pressure;
optionally, subjecting the preform treated with the first supercritical fluid to a second treatment with a second supercritical fluid at a second temperature and a second pressure; and
foaming the resulting preform into a structure having predetermined shape and size.

2. The method according to claim 1, wherein the first temperature and the second temperature are identical to or different from each other, and are each 30° C. to 200° C.

3. The method according to claim 1, wherein the first pressure and the second pressure are identical to or different from each other, and are each 5 MPa to 60 MPa.

4. The method according to claim 1, wherein the first supercritical fluid and the second supercritical fluid are identical to or different from each other, and are each selected from the group consisting of carbon dioxide, water, methane, ethane, ethylene, propylene, methanol, ethanol, acetone, nitrogen gas and combinations thereof.

5. The method according to claim 1, wherein each of the first treatment and the second treatment is carried out for 5 minutes to 1 hour.

6. The method according to claim 1, wherein the first treatment comprises carrying out the treatment at a temperature of 90° C. to 180° C. and a pressure of 6 MPa to 40 MPa for 10 minutes to 50 minutes, and then optionally cooling to 50° C. or below; or
the first treatment comprises carrying out the treatment at a temperature of 100° C. to 150° C. and a pressure of 6.9 MPa to 34.5 MPa for 20 minutes to 30 minutes, and then optionally cooling to 30° C. or below.

7. The method according to claim 1, wherein the second treatment comprises carrying out the treatment at a temperature of 50° C. to 180° C. and a pressure of 10 MPa to 60 MPa for 15 minutes to 40 minutes.

8. The method according to claim 1, wherein the thermoplastic materials are selected from the group consisting of polyurethane, rubber, ethylene vinyl acetate, polyolefin, polystyrene copolymer, polyvinyl chloride, polyethylene terephthalate, thermoplastic acrylate and any combinations thereof.

9. The method according to claim 1, wherein the thermoplastic material is a thermoplastic polyurethane material represented by Formula 1: 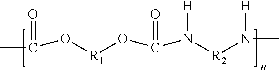
Formula 1
wherein R₁ and R₂ are each independently selected from the group consisting of substituted or unsubstituted linear or branched C₁₋₁₂ alkyl group, substituted or unsubstituted phenyl group, substituted or unsubstituted linear or branched C₁₋₁₂ alkylphenyl group, substituted or unsubstituted linear or branched C₁₋₁₂ ether group, substituted or unsubstituted linear or branched C₁₋₁₂ alkylhydroxy group, substituted or unsubstituted linear or branched C₁₋₁₂ alkoxy group, and substituted or unsubstituted linear or branched C₃₋₁₂ cycloalkoxy group, wherein n is any integer of less than or equal to 150.

10. The method according to claim 1, wherein the preform is produced by injection molding, extrusion molding, hot-press molding, or casting molding.

11. A foamed structure prepared by the method according to claim 1.

12. An article selected from sports equipment, packaging materials and shoe materials comprising the foamed structure according to claim 11.
